(19) United States
(12) Patent Application Publication
(10) Pub. No.: US 2025/0358698 A1
(43) Pub. Date: Nov. 20, 2025

(54) DATA FORWARDING IN LOWER-LAYER MOBILITY

(71) Applicant: Nokia Technologies Oy, Espoo (FI)

(72) Inventors: Panagiotis SPAPIS, Munich (DE); Halit Murat GÜRSU, Munich (DE); Subramanya CHANDRASHEKAR, Bangalore (IN); Ahmad AWADA, Munich (DE); Srinivasan SELVAGANAPATHY, Bangalore (IN); Guillaume DECARREAU, Munich (DE)

(21) Appl. No.: 18/867,313

(22) PCT Filed: May 20, 2022
(86) PCT No.: PCT/EP2022/063721

§ 371 Date: Nov. 19, 2024

(51) Int. Cl. H04W 36/08; H04W 36/00

(52) U.S. Cl. CPC H04W 36/08; H04W 36/0033

(57) ABSTRACT

There are provided measures for enabling/realizing efficient/favorable data forwarding in lower-layer mobility in/for a mobile communication system, namely a radio access network of a mobile communication system, such as L1/L2 centric mobility. Such measures exemplarily comprise that a lower-layer entity in a radio access network of a mobile communication system obtains a configuration of lower-layer mobility and data forwarding in lower-layer mobility from a higher-layer control plane entity, initiates data forwarding to at least one target cell of lower-layer mobility in accordance with the configuration, and notifies a higher-layer user plane entity of initiation of data forwarding, wherein the at least one target cell of lower-layer mobility is identified. The configuration may indicate on-time data forwarding, wherein data forwarding to a target cell is triggered when a serving cell change decision is completed, or ay indicate early data forwarding upon preparation of candidate target cells for lower-layer mobility, wherein data forwarding to at least one of one or more candidate target cells is triggered when candidate target cells preparation is completed.

### FIELD

The present disclosure relates to data forwarding in lower-layer mobility in/for a mobile communication system. More specifically, the present disclosure relates to measures/mechanisms (including methods, apparatuses (i.e. devices, entities, elements, instances and/or functions) and computer program products) for enabling/realizing data forwarding in lower-layer mobility in/for a radio access network of a mobile communication system, such as L1/L2 centric mobility.

### BACKGROUND

The present disclosure basically relates to lower-layer mobility in/for (a radio access network of) a mobile communication system, e.g. a 3GPP-standardized mobile/wireless communication system, such as a 5G/NR system and a next-generation system beyond 5G. Generally, lower-layer mobility stands for (user equipment or mobile terminal) mobility being accomplished and/or performed on/by/via lower layers of an applicable protocol stack, such as e.g. physical (L1) and data link (L2) layers of the OSI model.

Herein, L1/L2 centric mobility is exemplified as a realization of lower-layer mobility, and can be regarded as (an example of) lower-layer mobility. In L1/L2 centric mobility, the decision about a cell change, i.e. handover, is based on L1 measurements and is made in the MAC layer (on L2) in a lower-layer entity such as a communication control entity like the gNB or, more specifically, the Distributed Unit (DU) of the gNB. Accordingly, L1/L2 centric mobility can equally be referred to or regarded as L1/L2 based inter-cell mobility/handover.

In a typical procedure of lower-layer mobility and associated late data forwarding (as illustrated in FIG. 4 explained below), the UE receives data from the Source DU until the Source DU decides that the UE should be handed over to another DU (i.e. the Target DU) and thus triggers the cell/path switch. Then, the UE performs a handover procedure, such as e.g. RA-based handover, RACH-less handover, or the like. Herein, it is exemplarily assumed that the UE performs Random Access (RA) to the target cell, i.e. the Target DU. After the RA procedure, the UE transmits an RRC Reconfiguration Complete to the target cell, i.e. the Target DU, which is forwarded to the CU-CP. The CU-CP performs bearer modification with the CU-UP to update the bearer setup and for the CU-UP to start forwarding the data to the Target DU (and stop forwarding data to the Source DU). Once this is completed, the UE starts receiving data from the Target. In this case, the UE will experience a (service) interruption for the time required to perform the cell/path switch from the Source DU to the Target DU and to initiate the data forwarding from the CU-UP to the Target DU.

In another typical procedure of lower-layer mobility and associated early data forwarding, the CU-UP can start forwarding the data to all potential/candidate target cells, i.e. Target DUs, (and stop forwarding data to the Source DU) when the preparation of the potential/candidate target cells, i.e. Target DUs, is completed, namely even prior to a handover decision by the Source DU. In this case, the data will be available in the target cell once e.g. the RA procedure (i.e. any handover procedure) to the finally selected target cell, i.e. the final Target DU, is completed, leading to a shorter (service) interruption. But this will result in higher (signaling) overhead, as data forwarding to all potential/candidate target cells, i.e. Target DUs, is required up to the final handover decision, which is a waste of network resources.

While L1/L2 centric mobility aims at reducing the latency, (signaling) overhead and (service) interruption time, reducing (service) interruption time and reducing (signaling) overhead are conflicting objectives, as evident from the above.

With available mechanisms for L1/2 centric mobility as described above, the conflicting issues are as follows.
In on-time data forwarding, the data is forwarded to the target cell after the handover procedure such as e.g. the RA procedure, i.e. after the reception of the associated RRC Reconfiguration Complete at the Target DU (cf. step 17 in FIG. 4), confirming the handover execution. Yet, this results in a long (service) interruption time.
In early data forwarding, the data is forwarded to prepared potential/candidate target cells after cell preparation, i.e. after the reception of the associated RRC Reconfiguration Complete at the Source DU (cf. step 10 in FIG. 4), confirming the cell preparation. Yet, this results in higher (signaling) overhead (such as buffer space for storage, discarding transmitted PDUs, etc.), as data will be forwarded early to multiple potential/candidate target cells. Especially considering that the target cells may be prepared early, the data has to be forwarded to the target cells for an increased duration; considering dynamic switch solutions, where the UE changes dynamically among target cells, the problem becomes even more acute.

Therefore, there is room for improvement and a desire/need for a technique for (enabling/realizing) efficient/favorable data forwarding in lower-layer mobility in/for a mobile communication system, namely a radio access network of a mobile communication system, such as L1/L2 centric mobility. In particular, there is room for improvement and a desire/need for a technique for facilitating reduced (service) interruption time and/or reduced (signaling) overhead in/for data forwarding in lower-layer mobility, such as L1/L2 centric mobility.

### SUMMARY

Various exemplifying embodiments of the present disclosure aim at addressing at least part of the above issues and/or problems and drawbacks.

Various aspects of exemplifying embodiments of the present disclosure are set out in the appended claims.

According to an example aspect of the present disclosure, there is provided a method of (or, stated in other words, operable or for use in/by) a lower-layer entity in a radio access network of a mobile communication system, comprising: obtaining a configuration of lower-layer mobility and data forwarding in lower-layer mobility from a higher-layer control plane entity, initiating data forwarding to at least one target cell of lower-layer mobility in accordance with the configuration, and notifying a higher-layer user plane entity of initiation of data forwarding, wherein the at least one target cell of lower-layer mobility is identified.

According to an example aspect of the present disclosure, there is provided an apparatus of (or, stated in other words, operable or for use in/by) a lower-layer entity in a radio access network of a mobile communication system, the apparatus comprising at least one processor and at least one memory including computer program code, wherein the processor, with the at least one memory and the computer program code, is configured to cause the apparatus to perform: obtaining a configuration of lower-layer mobility and data forwarding in lower-layer mobility from a higher-layer control plane entity, initiating data forwarding to at least one target cell of lower-layer mobility in accordance with the configuration, and notifying a higher-layer user plane entity of initiation of data forwarding, wherein the at least one target cell of lower-layer mobility is identified.

According to an example aspect of the present disclosure, there is provided an apparatus of (or, stated in other words, operable or for use in/by) a lower-layer entity in a radio access network of a mobile communication system, comprising: means for obtaining a configuration of lower-layer mobility and data forwarding in lower-layer mobility from a higher-layer control plane entity, means for initiating data forwarding to at least one target cell of lower-layer mobility in accordance with the configuration, and means for notifying a higher-layer user plane entity of initiation of data forwarding, wherein the at least one target cell of lower-layer mobility is identified.

According to various developments/modifications, any one of the aforementioned method-related and/or apparatus-related example aspects of the present disclosure may include one or more of the following features:
the configuration indicates on-time data forwarding upon decision of serving cell change for lower-layer mobility,
the initiating comprises: making a serving cell change decision for a target cell for lower-layer mobility, and triggering data forwarding to the target cell when the serving cell change decision is completed,
the notifying comprises issuing a notification to the higher-layer user plane entity, said notification including an indication of the serving cell change decision and an identifier for the target cell,
the notifying comprises issuing a notification to the higher-layer control plane entity, for informing the higher-layer user plane entity, said notification including an indication of the serving cell change decision, an indication of the property of the serving cell change as a change between serving cells relating to different lower-layer entities and an identifier for the target cell,
the configuration indicates early data forwarding upon preparation of candidate target cells for lower-layer mobility,
the initiating comprises: conducting a candidate target cells preparation for one or more candidate target cells for lower-layer mobility, and triggering data forwarding to at least one of the one or more candidate target cells when the candidate target cells preparation is completed,
the conducting comprises making an upcoming serving cell change decision for a target cell among the one or more candidate target cells for lower-layer mobility, and the data forwarding is triggered when the upcoming serving cell change decision is completed,
the notifying comprises issuing a notification to the higher-layer user plane entity, said notification including an indication of application of the early data forwarding and an identifier for the at least one of the one or more candidate target cells
the notifying comprises issuing a notification to the higher-layer control plane entity, for informing the higher-layer user plane entity, said notification including an indication of application of the early data forwarding, an indication of the property of an upcoming serving cell change as a change between serving cells relating to different lower-layer entities and an identifier for the at least one of the one or more candidate target cells,
the method, functionality or operability comprises making a serving cell change decision for a target cell among the one or more candidate target cells for lower-layer mobility, and notifying the higher-layer user plane entity of the serving cell change decision,
the notifying of the serving cell change decision comprises issuing a notification to the higher-layer user plane entity, said notification including an indication of a downlink data delivery status indicating downlink data having been acknowledged by a user equipment element or function as a destination,
the notifying of the serving cell change decision further comprises issuing a notification to the higher-layer user plane entity, said notification including an indication of the serving cell change decision and an identifier for the target cell,
the notifying of the serving cell change decision further comprises issuing a notification to the higher-layer control plane entity, for informing the higher-layer user plane entity, said notification including an indication of the serving cell change decision, an indication of the property of the serving cell change as a change between serving cells relating to different lower-layer entities and an identifier for the target cell,
the method, functionality or operability comprises making an early data forwarding cancellation decision for cancelling the early data forwarding, and notifying the higher-layer user plane entity of the early data forwarding cancellation decision,
the notifying of the early data forwarding cancellation decision comprises issuing a notification to the higher-layer user plane entity or to the higher-layer control plane entity, for informing the higher-layer user plane entity, said notification including an indication of cancellation of the early data forwarding,
the data forwarding is initiated based on lower-layer measurements, particularly Layer 1 measurements, from a user equipment element or function,
in the notifying the at least one target cell of lower-layer mobility is identified using or based on its global cell identifier or its physical cell identifier,
the configuration comprises an index for each potential target cell of lower-layer mobility,
in the notifying the at least one target cell of lower-layer mobility is identified using or based on its index in the configuration,
   the lower-layer entity is or comprises a functional unit providing support for lower layers, such as Layer 1 and/or Layer 2, of a protocol stack for communication in the radio access network and/or the mobile communication system,
the lower-layer entity is or comprises a distributed unit of a communication control element or function in the radio access network and, such as a base station or Node B,
the higher-layer control/user plane entity is or comprises a functional unit providing support for control/user plane functionality of higher layers, such as Layer 3, of a protocol stack for communication in the radio access network and/or the mobile communication system,
the lower-layer mobility is or comprises mobility, such as an inter-cell handover, on or controlled on lower layers, such as Layer 1 and/or Layer 2, of a protocol stack for communication in the radio access network and/or the mobile communication system,
the lower-layer entity is related to a cell which currently serves a user equipment element or function and/or represents a source cell of lower-layer mobility.

According to an example aspect of the present disclosure, there is provided a method of (or, stated in other words, operable or for use in/by) a higher-layer control plane entity in a radio access network of a mobile communication system, comprising: establishing a configuration of lower-layer mobility and data forwarding in lower-layer mobility, and providing the configuration to a lower-layer entity.

According to an example aspect of the present disclosure, there is provided an apparatus of (or, stated in other words, operable or for use in/by) a higher-layer control plane entity in a radio access network of a mobile communication system, the apparatus comprising at least one processor and at least one memory including computer program code, wherein the processor, with the at least one memory and the computer program code, is configured to cause the apparatus to perform: establishing a configuration of lower-layer mobility and data forwarding in lower-layer mobility, and providing the configuration to a lower-layer entity.

According to an example aspect of the present disclosure, there is provided an apparatus of (or, stated in other words, operable or for use in/by) a higher-layer control plane entity in a radio access network of a mobile communication system, comprising: means for establishing a configuration of lower-layer mobility and data forwarding in lower-layer mobility, and means for providing the configuration to a lower-layer entity.

According to various developments/modifications, any one of the aforementioned method-related and/or apparatus-related example aspects of the present disclosure may include one or more of the following features:
the configuration indicates on-time data forwarding upon decision of serving cell change for lower-layer mobility,
the method, functionality or operability comprises obtaining a notification of bearer context modification from a higher-layer user plane entity, said notification including an indication of a serving cell change decision by the lower-layer entity and an indication of initiation of data forwarding to a target cell for lower-layer mobility,
the method, functionality or operability comprises obtaining a notification from the lower-layer entity, said notification including an indication of a serving cell change decision by the lower-layer entity, an indication of the property of the serving cell change as a change between serving cells relating to different lower-layer entities and an identifier for a target cell for lower-layer mobility, and informing a higher-layer user plane entity about initiation of data forwarding to the target cell based on the notification,
the informing comprises causing bearer context modification at the higher-layer user plane entity for enabling the higher-layer user plane entity to perform data forwarding to the target cell,
the configuration indicates early data forwarding upon preparation of candidate target cells for lower-layer mobility,
the method, functionality or operability comprises obtaining a notification of bearer context modification from a higher-layer user plane entity, said notification including an indication of an upcoming serving cell change decision by the lower-layer entity and an indication of initiation of data forwarding to at least one of one or more candidate target cells for lower-layer mobility,
the method, functionality or operability comprises obtaining a notification from the lower-layer entity, said notification including an indication of application of the early data forwarding by the lower-layer entity, an indication of the property of an upcoming serving cell change as a change between serving cells relating to different lower-layer entities and an identifier for the at least one of the one or more candidate target cells, and informing a higher-layer user plane entity about initiation of the early data forwarding to the at least one of one or more candidate target cells based on the notification,
the informing comprises causing bearer context modification at the higher-layer user plane entity for enabling the higher-layer user plane entity to perform the early data forwarding to the at least one of one or more candidate target cells,
the method, functionality or operability comprises obtaining a notification of bearer context modification from a higher-layer user plane entity, said notification including an indication of a serving cell change decision by the lower-layer entity and an indication of initiation of data forwarding to a target cell for lower-layer mobility,
the method, functionality or operability comprises causing bearer context modification at a higher-layer user plane entity for enabling the higher-layer user plane entity to perform data forwarding to the target cell,
the identifier for a target cell is or is based on its global cell identifier or its physical cell identifier,
the method, functionality or operability comprises setting an index for each potential target cell of lower-layer mobility,
the index for each potential target cell of lower-layer mobility is provided to the lower-layer entity in the configuration and to a higher-layer user plane entity,
an identifier for a target cell is or is based on its index,
the higher-layer control plane entity is or comprises a functional unit providing support for control plane functionality of higher layers, such as Layer 3, of a protocol stack for communication in the radio access network and/or the mobile communication system,
the lower-layer entity is or comprises a functional unit providing support for lower layers, such as Layer 1 and/or Layer 2, of a protocol stack for communication in the radio access network and/or the mobile communication system,
the lower-layer entity is or comprises a distributed unit of a communication control element or function in the radio access network and, such as a base station or Node B,
the lower-layer mobility is or comprises mobility, such as an inter-cell handover, on or controlled on lower layers, such as Layer 1 and/or Layer 2, of a protocol stack for communication in the radio access network and/or the mobile communication system,
the lower-layer entity is related to a cell which currently serves a user equipment element or function and/or represents a source cell of lower-layer mobility.

According to an example aspect of the present disclosure, there is provided a method of (or, stated in other words, operable or for use in/by) a higher-layer user plane entity in a radio access network of a mobile communication system, comprising: obtaining notifying information of initiation of data forwarding in lower-layer mobility by a lower-layer entity, and performing data forwarding in accordance with the notifying information.

According to an example aspect of the present disclosure, there is provided an apparatus of (or, stated in other words, operable or for use in/by) a higher-layer user plane entity in a radio access network of a mobile communication system, the apparatus comprising at least one processor and at least one memory including computer program code, wherein the processor, with the at least one memory and the computer program code, is configured to cause the apparatus to perform: obtaining notifying information of initiation of data forwarding in lower-layer mobility by a lower-layer entity, and performing data forwarding in accordance with the notifying information.

According to an example aspect of the present disclosure, there is provided an apparatus of (or, stated in other words, operable or for use in/by) a higher-layer user plane entity in a radio access network of a mobile communication system, comprising: means for obtaining notifying information of initiation of data forwarding in lower-layer mobility by a lower-layer entity, and means for performing data forwarding in accordance with the notifying information.

According to various developments/modifications, any one of the aforementioned method-related and/or apparatus-related example aspects of the present disclosure may include one or more of the following features:
the notifying information indicates on-time data forwarding upon decision of serving cell change for lower-layer mobility.
the obtaining comprises obtaining a notification from the lower-layer entity, said notification including an indication of a serving cell change decision by the lower-layer entity and an identifier for a target cell for lower-layer mobility,
the method, functionality or operability comprises issuing a notification of bearer context modification to a higher-layer control plane entity, said notification including an indication of a serving cell change decision by the lower-layer entity and an indication of initiation of data forwarding to a target cell for lower-layer mobility,
the obtaining comprises obtaining information about initiation of data forwarding to the target cell from a higher-layer control plane entity, said information enabling to perform data forwarding to the target cell,
said information causes bearer context modification at the higher-layer user plane entity for enabling to perform data forwarding to the target cell,
the notifying information indicates early data forwarding upon preparation of candidate target cells for lower-layer mobility,
the obtaining comprises obtaining a notification from the lower-layer entity, said notification including an indication of application of the early data forwarding to at least one of one or more candidate target cells and an identifier for the at least one of one or more candidate target cells for lower-layer mobility,
the method, functionality or operability comprises issuing a notification of bearer context modification to a higher-layer control plane entity, said notification including an indication of an upcoming serving cell change decision by the lower-layer entity and an indication of initiation of data forwarding to at least one of one or more candidate target cells for lower-layer mobility,
the obtaining comprises obtaining information about initiation of the early data forwarding to at least one of one or more candidate target cells from a higher-layer control plane entity, said information enabling to perform the early data forwarding to the at least one of one or more candidate target cells,
said information causes bearer context modification at the higher-layer user plane entity for enabling to perform the early data forwarding to the at least one of one or more candidate target cells,
the method, functionality or operability comprises obtaining a notification from the lower-layer entity, said notification including an indication of a downlink data delivery status indicating downlink data having been acknowledged by a user equipment element or function as a destination,
the method, functionality or operability comprises obtaining a notification from the lower-layer entity, said notification including an indication of a serving cell change decision and an identifier for a target cell for lower-layer mobility,
the method, functionality or operability comprises obtaining information about a serving cell change decision from a higher-layer control plane entity, said information including an indication of the serving cell change decision and an identifier for a target cell for lower-layer mobility,
the method, functionality or operability comprises obtaining a notification from the lower-layer entity or via a higher-layer control plane entity, said notification including an indication of cancellation of the early data forwarding,
the identifier for a target cell is or is based on its global cell identifier or its physical cell identifier or its index being set or configured among an index for each potential target cell of lower-layer mobility,
the higher-layer user plane entity is or comprises a functional unit providing support for user plane functionality of higher layers, such as Layer 3, of a protocol stack for communication in the radio access network and/or the mobile communication system,
the lower-layer entity is or comprises a functional unit providing support for lower layers, such as Layer 1 and/or Layer 2, of a protocol stack for communication in the radio access network and/or the mobile communication system,
the lower-layer entity is or comprises a distributed unit of a communication control element or function in the radio access network and, such as a base station or Node B,
the lower-layer mobility is or comprises mobility, such as an inter-cell handover, on or controlled on lower layers, such as Layer 1 and/or Layer 2, of a protocol stack for communication in the radio access network and/or the mobile communication system,
the lower-layer entity is related to a cell which currently serves a user equipment element or function and/or represents a source cell of lower-layer mobility.

According to an example aspect of the present disclosure, there is provided a computer program product comprising (computer-executable) computer program code which, when the program code is executed (or run) on a computer or the program is run on a computer (e.g. a computer of an apparatus according to any one of the aforementioned apparatus-related example aspects of the present disclosure), is configured to cause the computer to carry out the method according any one of the aforementioned method-related example aspects of the present disclosure.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned exemplary aspects of the present disclosure are set out in the following.

By way of exemplifying embodiments of the present disclosure, a technique for (enabling/realizing) efficient/favorable data forwarding in lower-layer mobility in/for a mobile communication system, namely a radio access network of a mobile communication system, such as L1/L2 centric mobility, can be enabled/realized. Also, a technique for facilitating reduced (service) interruption time and/or reduced (signaling) overhead in/for data forwarding in lower-layer mobility, such as L1/L2 centric mobility, can be enabled/realized.

### BRIEF DESCRIPTION OF THE DRAWINGS

In the following, the present disclosure will be described in greater detail by way of non-limiting examples with reference to the accompanying drawings, in which

FIG. 1 shows a flowchart illustrating an example of a method or process according to at least one exemplifying embodiment,

FIG. 2 shows a flowchart illustrating an example of a method or process according to at least one exemplifying embodiment,

FIG. 3 shows a flowchart illustrating an example of a method or process according to at least one exemplifying embodiment,

FIG. 4 shows a sequence diagram illustrating an example of a procedure of lower-layer mobility and data forwarding as a basis of at least one exemplifying embodiment,

FIG. 5 shows a sequence diagram illustrating an example of a procedure of lower-layer mobility and on-time data forwarding according to at least one exemplifying embodiment,

FIG. 6 shows a sequence diagram illustrating an example of a procedure of lower-layer mobility and early data forwarding according to at least one exemplifying embodiment,

FIG. 7 shows a schematic block diagram illustrating an example of a structure of apparatuses according to at least one exemplifying embodiment, and

FIG. 8 shows a schematic block diagram illustrating an example of a structure of an apparatuses according to at least one exemplifying embodiment.

### DETAILED DESCRIPTION

The present disclosure is described herein with reference to particular non-limiting examples and to what are presently considered to be conceivable (examples of) embodiments. A person skilled in the art will appreciate that the present disclosure is by no means limited to these examples and embodiments, and may be more broadly applied.

It is to be noted that the following description mainly refers to specifications being used as non-limiting examples for certain exemplifying network configurations and system deployments. Namely, the following description mainly refers to 3GPP standards, being used as non-limiting examples. As such, the description of exemplifying embodiments given herein specifically refers to terminology which is directly related thereto. Such terminology is only used in the context of the presented non-limiting examples and embodiments, and does naturally not limit the present disclosure in any way. Rather, any other system configuration or deployment may equally be utilized as long as complying with what is described herein and/or exemplifying embodiments described herein are applicable to it.

For example, the present disclosure is equally applicable in any (mobile/wireless) communication system, such as 5G/NR systems and next-generation systems beyond 5G. For example, the present disclosure is applicable in 3GPP-standardized mobile/wireless communication system of Release 18 onwards.

Hereinafter, various exemplifying embodiments and implementations of the present disclosure and its aspects are described using several variants and/or alternatives. It is generally to be noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is to be noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown. In flowcharts or sequence diagrams, the illustrated order of operations or actions is generally illustrative/exemplifying, and any other order of respective operations or actions is equally conceivable, if feasible.

According to exemplifying embodiments of the present disclosure, in general terms, there are provided measures/mechanisms for (enabling/realizing) efficient/favorable data forwarding in lower-layer mobility in/for a mobile communication system, namely a radio access network of a mobile communication system, such as L1/L2 centric mobility. Also, there are provided measures/mechanisms for facilitating reduced (service) interruption time and/or reduced (signaling) overhead in/for data forwarding in lower-layer mobility, such as L1/L2 centric mobility.

Hereinafter, a specific configuration/architecture of a radio access network, particularly a communication control entity (such as a gNB) in/for a radio access network, of a 3GPP-based/related system, is assumed as a basis, for illustrating exemplifying embodiments (without limiting the present disclosure accordingly). Namely, it is assumed that the radio access network or the communication control entity (such as a gNB) comprises plural lower-layer entities for controlling and/or supporting and/or accomplishing lower-layer operability, such as L1/L2 operability, and a higher-layer entity for controlling and/or supporting and/or accomplishing higher-layer operability, such as L3 operability, wherein the higher-layer entity is (logically and/or functionally and/or physically) split into a higher-layer control plane entity for handling control plane (CP) operability and a higher-layer user plane entity for handling user plane (UP) operability. Each of the lower-layer entity may be (realized by or in) a Distributed Unit DU (of/in a gNB), the higher-layer control plane entity may be (realized by or in) a Central Unit—Control Plane CU-CP, and the higher-layer user plane entity may be (realized by or in) a Central Unit—User Plane CU-UP.

With regard to L1/L2 centric mobility (L1/L2 based inter-cell mobility/handover), it is assumed that a user equipment (element or function) is initially served/controlled by a lower-layer entity, i.e. camping in a cell of the lower-layer entity, typically referred to as source cell or Source DU, and is to be handed over to another lower-layer entity, i.e. switched to a cell of the other lower-layer entity, typically referred to as target cell or Target DU. Accordingly, L1/L2 centric mobility (L1/L2 based inter-cell mobility/handover) relates to a serving cell change as a change between serving cells relating to different lower-layer entities, also referred to as inter-DU case, for illustrating exemplifying embodiments (without limiting the present disclosure accordingly).

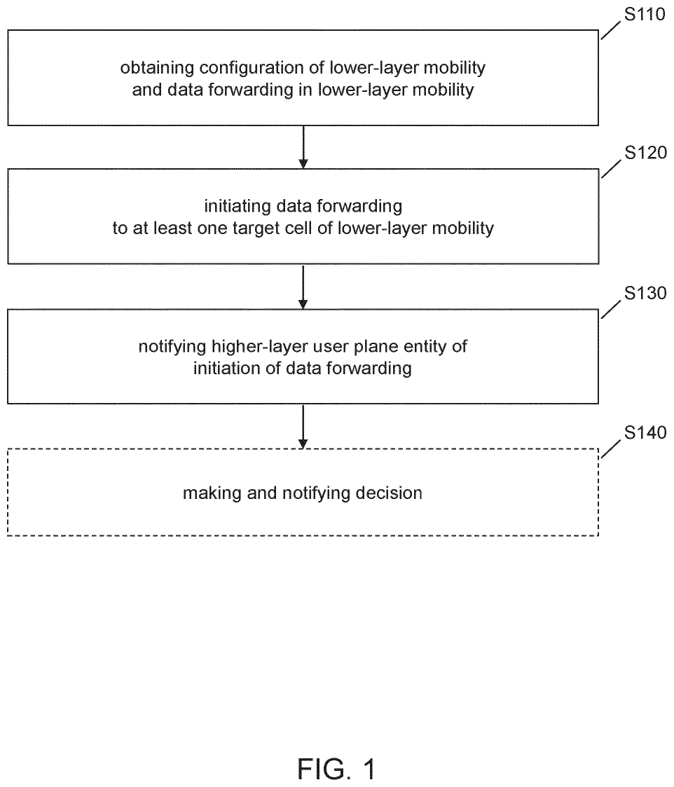

FIG. 1 shows a flowchart illustrating an example of a method or process according to at least one exemplifying embodiment. The method or process of FIG. 1 is a method or process of (or, stated in other words, operable or for use in/by) a lower-layer entity, or an element, function or entity of similar/comparable functionality or operability, in/for a radio access network of a mobile communication system, such as a communication and/or communication control unit like a Distributed Unit DU (of/in a gNB) in/for a 3GPP network or system.

As shown in FIG. 1, the method or process comprises an operation (S110) of obtaining a configuration of lower-layer mobility and data forwarding in lower-layer mobility from a higher-layer control plane entity, an operation (S120) of initiating data forwarding to at least one target cell of lower-layer mobility in accordance with the configuration, and an operation (S130) of notifying a higher-layer user plane entity of initiation of data forwarding, wherein the at least one target cell of lower-layer mobility is identified.

As indicated by dashed lines in FIG. 1, the method or process may additionally comprise an operation (S140) of making a decision (such as e.g. serving cell change decision or an early data forwarding cancellation decision), and notifying the higher-layer user plane entity of the decision.

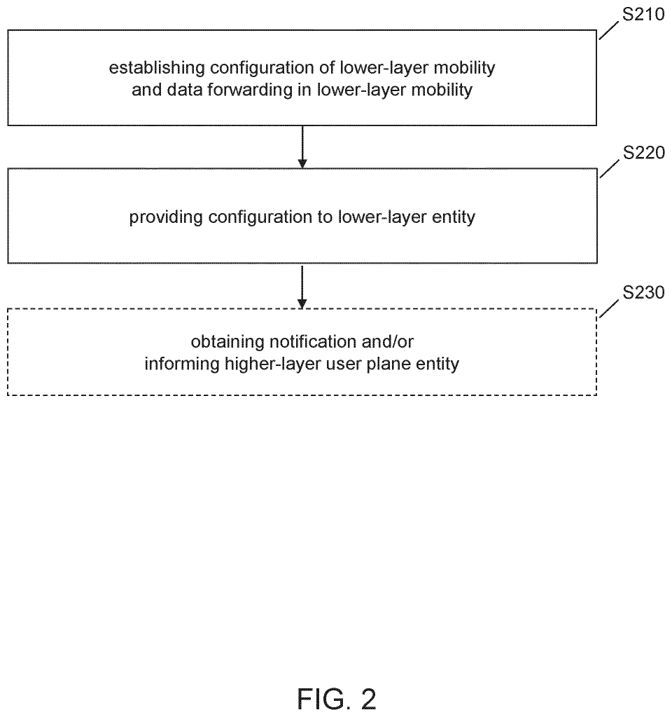

FIG. 2 shows a flowchart illustrating an example of a method or process according to at least one exemplifying embodiment. The method or process of

FIG. 2 is a method or process of (or, stated in other words, operable or for use in/by) a higher-layer control plane entity, or an element, function or entity of similar/comparable functionality or operability, in/for a radio access network of a mobile communication system, such as a communication and/or communication control unit like a Central Unit-Control Plane CU-CP (of/in a gNB) in/for a 3GPP network or system.

As shown in FIG. 2, the method or process comprises an operation (S210) of establishing a configuration of lower-layer mobility and data forwarding in lower-layer mobility, and an operation (S220) of providing the configuration to a lower-layer entity.

As indicated by dashed lines in FIG. 2, the method or process may additionally comprise an operation (S230) of obtaining a notification and/or informing a higher-layer user plane entity on the notification.

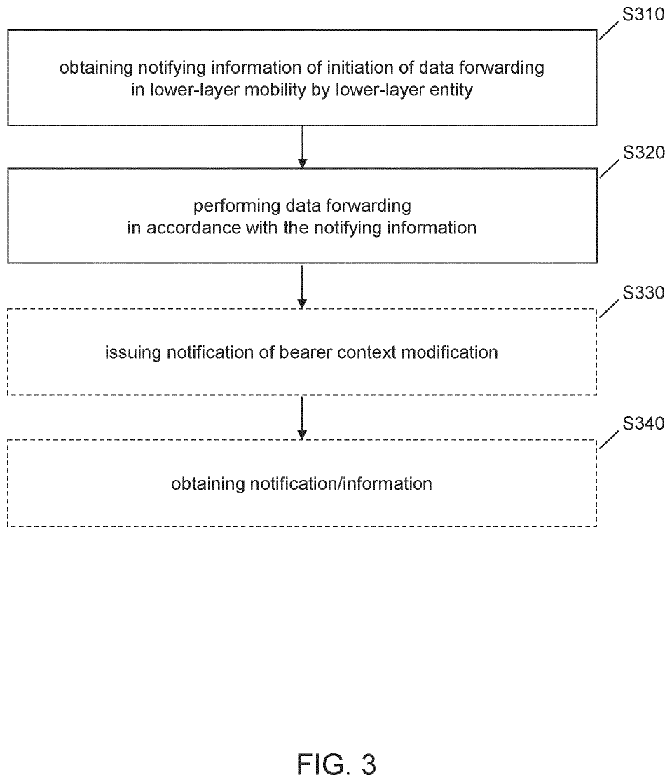

FIG. 3 shows a flowchart illustrating an example of a method or process according to at least one exemplifying embodiment. The method or process of FIG. 3 is a method or process of (or, stated in other words, operable or for use in/by) a higher-layer user plane entity, or an element, function or entity of similar/comparable functionality or operability, in/for a radio access network of a mobile communication system, such as a communication and/or communication control unit like a Central Unit-User Plane CU-UP (of/in a gNB) in/for a 3GPP network or system.

As shown in FIG. 3, the method or process comprises an operation (S310) of obtaining notifying information of initiation of data forwarding in lower-layer mobility by a lower-layer entity, and an operation (S320) of performing data forwarding in accordance with the notifying information.

As indicated by dashed lines in FIG. 3, the method or process may additionally comprise an operation (S330) of issuing a notification of bearer context modification to a higher-layer control plane entity.

As indicated by dashed lines in FIG. 3, the method or process may additionally comprise an operation (S340) of obtaining a notification from the lower-layer entity and/or an information from a higher-layer control plane entity.

It is to be noted that the steps/operations of the above-outlined procedures are not necessarily to be performed in the sequence as illustrated by FIGS. 1 and 3, unless such sequence is (described to be) technically required. For example, steps/operations S330 and S340 in FIG. 3 can be performed in a different order.

Herein, an operation of notifying/providing/issuing shall generally encompass any way of causing/initiating/provoking a corresponding transmission and/or performing/realizing an actual transmission, and an operation of obtaining shall generally encompass performing/realizing any way of an actual reception and/or acquiring/processing/accepting upon a corresponding reception. Any sent/obtained data, information, notification, indication or the like may be provided as such (e.g. in/as a dedicated element), as contents of/in some message (in any conceivable form/format), or in any other way, as long as it can thereby be sent/obtained accordingly.

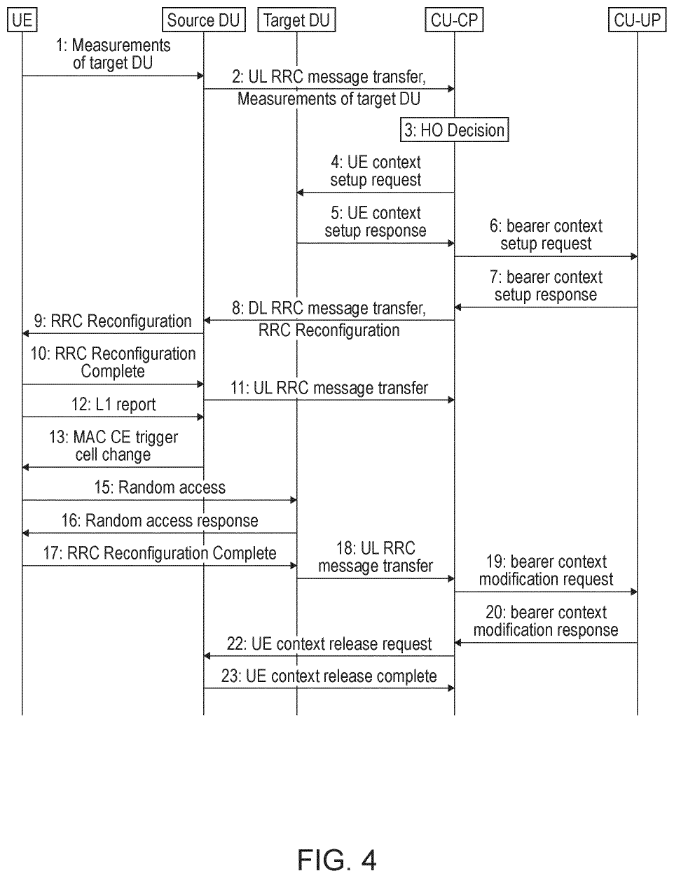

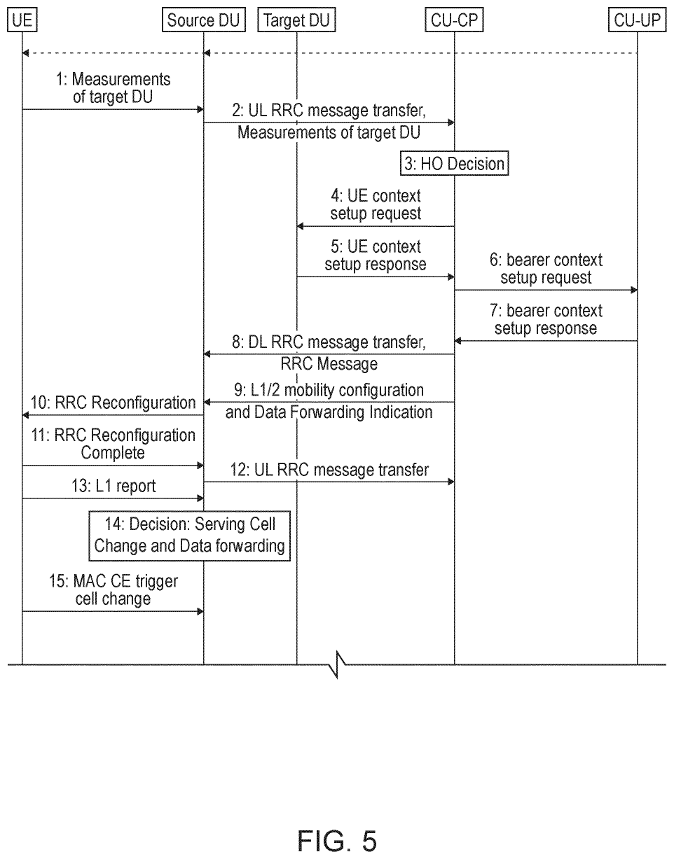

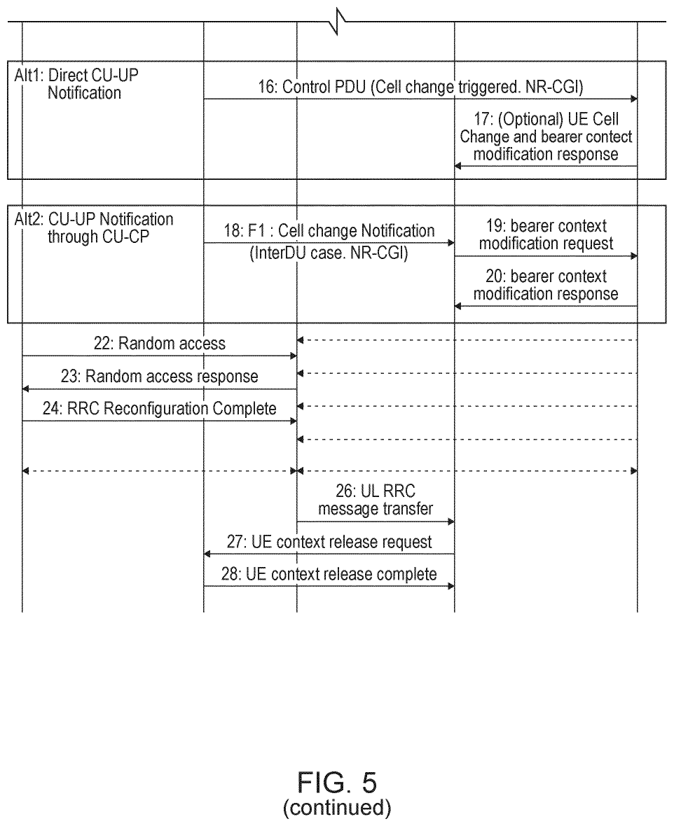

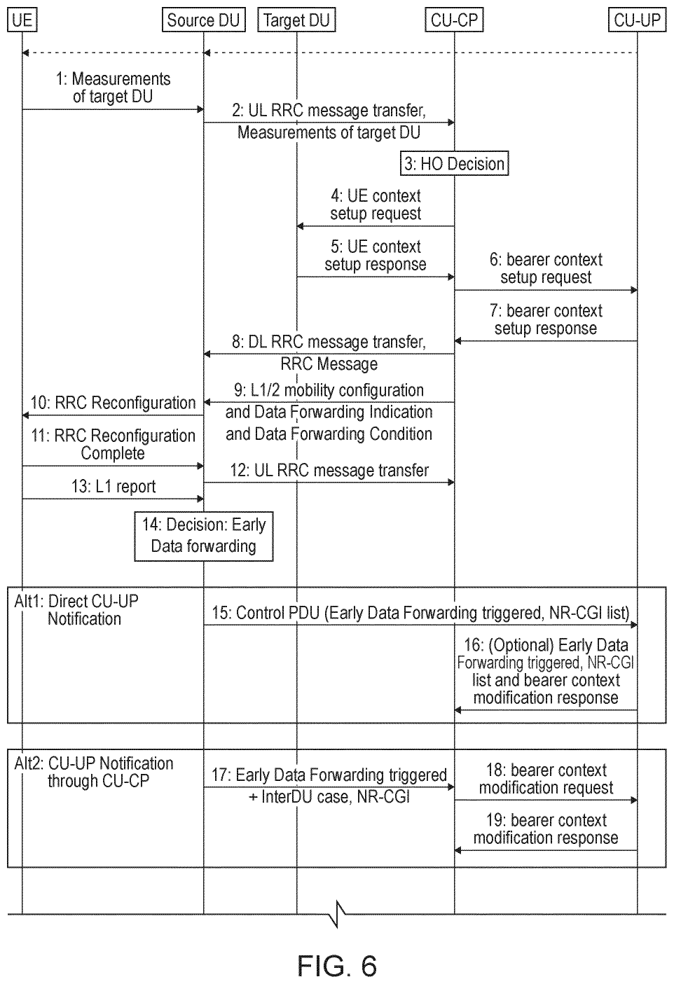

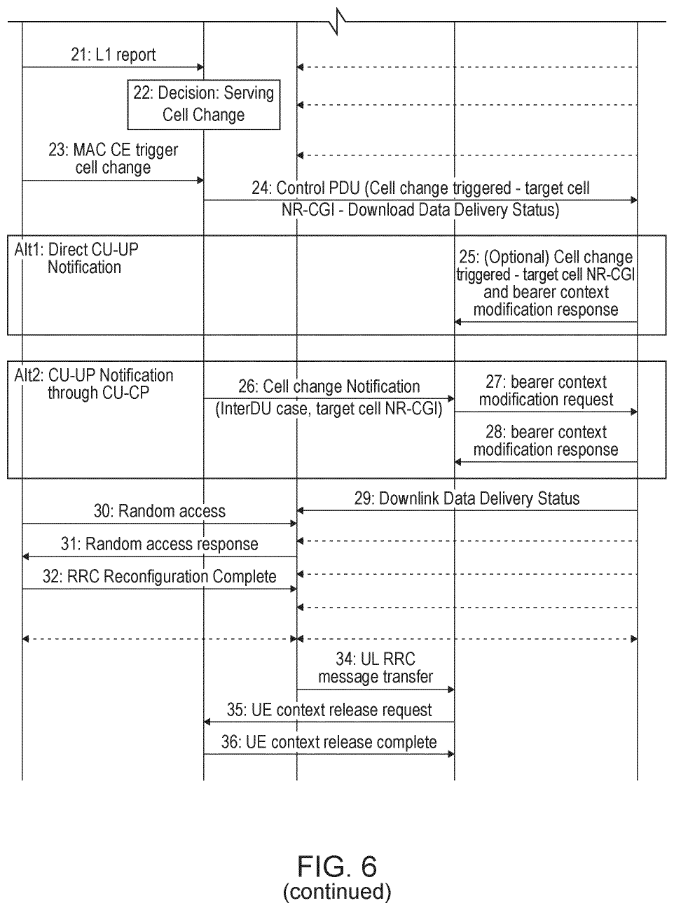

In the following, exemplarily procedures of conceivable use cases are exemplified with regard to an example configuration/architecture (as explained above) for illustrative purposes, without limiting the disclosure accordingly. While FIG. 4 illustrates a basis of lower-layer mobility and data forwarding, details and/or realization of the above-outlined operations are exemplified by FIGS. 5 and 6.

It is to be noted that the given message names in FIGS. 4 to 6 are exemplary, representing one non-limiting example realization, without limiting the present disclosure accordingly.

FIG. 4 shows a sequence diagram illustrating an example of a procedure of lower-layer mobility and data forwarding as a basis of at least one exemplifying embodiment.

The exemplary procedure of lower-layer mobility and late data forwarding of FIG. 4 is as follows.

In step 1, the UE provides L3 measurements to the Source DU, which are forwarded to the CU-CP in step 2. Based on these L3 measurements, the CU-CP decides about cell preparation (i.e. HO decision) in step 3, and proceeds in setting up the context in the Target DU in steps 4 and 5. Then, the CU-CP communicates with the CU-UP to perform the bearer context setup in steps 6 and 7.

In step 8, the CU-CP forwards the RRC Reconfiguration Request to the Source DU using a DL RRC Message Transfer, and the Source DU forwards this message to the UE in step 9. In steps 10 and 11, the UE responds with an RRC Reconfiguration Complete which is then forwarded from the Source DU to the CU-CP.

The UE based on its configuration provides periodic L1 reports to the Source DU, such as in step 12.

Once the Source DU decides that the UE should be handed over to another DU (i.e. Target DU), i.e. the Source DU makes a cell switch decision, it triggers the cell/path switch using a MAC CE in step 13. Up to this point, the UE receives data from the Serving DU, as illustrated in step 14.

Then, the UE applies the RRC configuration for the target cell, i.e. the Target DU, as indicated by the MAC CE, and performs a handover procedure, such as e.g. RA-based handover, RACH-less handover, or the like. Herein, it is exemplarily assumed that the UE performs Random Access (RA) to the target cell, i.e. the Target DU, in steps 15 and 16. After the RA procedure or any other (inter-DU) handover procedure, the UE in step 17 transmits an RRC Reconfiguration Complete to the target cell, i.e. the Target DU, which is forwarded to the CU-CP in step 18.

The CU-CP performs bearer modification with the CU-UP in steps 19 and 20 to update the bearer setup and for the CU-UP to start forwarding the data to the Target DU (and stop forwarding the data to the Source DU). Once this is completed, the UE starts receiving data from the Target DU, as illustrated in step 21.

Finally, the CU-CP releases the UE context from the Source DU with a UE Context Release Request in the operation of steps 22 and 23.

As described above, the UE will experience a (service) interruption for the time required to perform the cell/path switch from the Source DU to the Target DU and to initiate the data forwarding from the CU-UP to the Target DU, as the data is forwarded only after the reception of the RRC Reconfiguration Complete in step 17 of FIG. 4, i.e. upon confirming handover execution. When applying early data forwarding such that the data is forwarded already after the reception of the RRC Reconfiguration Complete in step 10 of FIG. 4, i.e. upon confirming cell preparation, the (service) interruption is shorter but the (signaling) overhead is higher, as data forwarding to all potential/candidate target cells, i.e. Target DUs, is required up to the final handover decision.

FIG. 5 shows a sequence diagram illustrating an example of a procedure of lower-layer mobility and on-time data forwarding according to at least one exemplifying embodiment.

In on-time data forwarding according to at least one exemplifying embodiment, the Source DU is enabled to inform the CU (i.e. CU-CP or CU-UP) about the serving cell change decision, i.e. decision of/for changing/switching to a target cell for lower-layer mobility, or, thus, the transmission of the serving cell change command (i.e. the corresponding MAC CE) to the UE, so as to initiate the data forwarding to the Target DU on time, i.e. within/upon the cell change decision/command.

The exemplary procedure of lower-layer mobility and on-time data forwarding of FIG. 5 is as follows.

Steps 1 to 8 are equivalent to steps 1 to 8 described above for FIG. 4, and thus reference is made to the related description of FIG. 4 for details.

In Step 9, the CU-CP configures L1/2 centric mobility and enables the data forwarding option. In this regard, the CU-CP establishes a configuration of L1/2 centric mobility and data forwarding, namely on-time data forwarding, and provides the configuration indicating on-time data forwarding to the Source DU.

Steps 10 to 12 are equivalent to steps 9 to 11 described above for FIG. 4, and thus reference is made to the related description of FIG. 4 for details.

In Step 14, the Source DU decides about the need for a serving cell change (or, stated in other words, a cell/path switch) and the initiation of the data forwarding to the Target DU, which can be accomplished based on the UE L1 measurements received in step 13.

In step 15, the Source DU sends a corresponding MAC CE to the UE to trigger the serving cell change.

Upon the triggering of the serving cell change (in steps 14/15), in one option/alternative denoted as “Direct CU-UP Notification”, the Source DU notifies the CU-UP about the serving cell change decision, wherein the identity of the target cell, i.e. the Target DU, is notified/informed, in step 16. This can be accomplished using a Control PDU. As illustrated, the notification or message can contain the NR-CGI of the target cell (as the target cell identity) to enable the cell/path switch, as the NR-CGI helps the CU-UP to identify the target cell, i.e. the Target DU. In an alternative implementation, the notification or message can contain the PCI of the target cell (as the target cell identity), where appropriate or sufficient.

Optionally, the CU-UP may inform the CU-CP about the bearer context modification based on the notification of the Source DU in step 17.

Upon the triggering of the serving cell change (in steps 14/15), in one option/alternative denoted as “CU-UP Notification through CU-CP”, the Source DU notifies the CU-CP about the serving cell change decision, wherein the identity of the target cell, i.e. the Target DU, is notified/informed and it is notified/informed that the serving cell change is an inter-DU cell change (i.e. the property of the serving cell change), in step 18. This can be accomplished using a corresponding notification or message. As illustrated, the notification or message can contain the NR-CGI of the target cell (as the target cell identity) to enable the CU-CP to perform bearer context modification with the CU-UP, i.e. issue a bearer context modification request to notify the CU-UP (thus enabling the CU-UP to perform the cell/path switch). In an alternative implementation, the notification or message can contain the PCI of the target cell (as the target cell identity), where appropriate or sufficient (together with the inter-DU cell change indication).

The CU-CP performs bearer modification with the CU-UP in steps 19 and 20 to update the bearer setup and for the CU-UP to start forwarding the data to the Target DU (and stop forwarding the data to the Source DU). Once this is completed, the data is forwarded to and thus available at the Target DU, as illustrated in step 21.

Then (or at least partially parallel with any one of the above notifications options/alternatives), the UE applies the RRC configuration for the target cell, i.e. the Target DU, as indicated by the MAC CE, and performs a handover procedure, such as e.g. RA-based handover, RACH-less handover, or the like. Herein, it is exemplarily assumed that the UE performs Random Access (RA) to the target cell, i.e. the Target DU, in steps 22 and 23. After the RA procedure or any other (inter-DU) handover procedure, the UE in step 24 transmits an RRC Reconfiguration Complete to the target cell, i.e. the Target DU, which is forwarded to the CU-CP in step 26. Upon the RRC Reconfiguration Complete in step 24, i.e. upon performing/completing the serving cell change to the target cell, the UE starts receiving data from the Target DU, as illustrated in step 25.

Steps 27 and 28 are equivalent to steps 22 and 23 described above for FIG. 4, and thus reference is made to the related description of FIG. 4 for details.

As evident from the above, on-time data forwarding according to at least one exemplifying embodiment provides that, upon the decision to send a serving cell change command (relating to a cell/path switch) to the UE, the Source DU informs the CU-CP or the CU-UP that the data forwarding should be initiated and indicates also the relevant target cell or Target DU, to which the handover will be executed. In this regard, the Source DU communicate its decision/indication to the CU-UP either directly or indirectly, namely to the CU-UP (e.g. using a Control PDU) or to the CU-CP and through that to the CU-UP (over the E1 interface or reference point there-between).

FIG. 6 shows a sequence diagram illustrating an example of a procedure of lower-layer mobility and early data forwarding according to at least one exemplifying embodiment.

In early data forwarding according to at least one exemplifying embodiment, the Source DU is enabled to inform the CU (CU-CP or CU-UP) about the candidate target cells preparation, i.e. decision of/for one or more candidate target cells for lower-layer mobility, or, thus, the likely (upcoming) transmission of the serving cell change command (i.e. the corresponding MAC CE) to the UE, so as to initiate the data forwarding to the potential/candidate target cells or Target DUs early, i.e. earlier than the cell change decision/command.

The exemplary procedure of lower-layer mobility and on-time data forwarding of FIG. 6 is as follows.

Steps 1 to 8 are equivalent to steps 1 to 8 described above for FIG. 4, and thus reference is made to the related description of FIG. 4 for details.

In Step 9, the CU-CP configures L1/2 centric mobility and enables the data forwarding option. In this regard, the CU-CP establishes a configuration of L1/2 centric mobility and data forwarding, namely early data forwarding, and provides the configuration indicating early data forwarding to the Source DU. Optionally, the CU-CP may also provide the Source DU a condition when to start and/or stop early data forwarding.

Steps 10 to 12 are equivalent to steps 9 to 11 described above for FIG. 4, and thus reference is made to the related description of FIG. 4 for details.

In Step 14, the Source DU decides to initiate early data forwarding to (at least some relevant one or ones of) candidate target cells or candidate Target DUs, which are determined as a result of the preceding candidate target cells preparation, which can be accomplished based on the UE L1 measurements received in step 13. In this regard, the Source DU may also decide or determine the need or expectation for an upcoming serving cell change (or, stated in other words, a future cell/path switch) for (at least some relevant one or ones of) candidate target cells or candidate Target DUs, and may initiate early data forwarding based on such decision or determination. Accordingly, data forwarding to at least one target cell, i.e. a subset of prepared target cells, is initiated, which can be based on the condition of starting early data forwarding (when provided by the CU-CP).

Upon the triggering of the early data forwarding (in step 14), in one option/alternative denoted as “Direct CU-UP Notification”, the Source DU notifies the CU-UP about the early data forwarding decision, wherein the identities of the candidate target cells, i.e. the Target DUs, is notified/informed, in step 15. This can be accomplished using a Control PDU. As illustrated, the notification or message can contain (a list of) the NR-CGIs of the candidate target cells (as the target cells identities) to enable (preparation or initiation of) the data forwarding, as the NR-CGI helps the CU-UP to identify the candidate target cells, i.e. the Target DUs, which are the destination of/for data forwarding. In an alternative implementation, the notification or message can contain (a list of) the PCIs of the candidate target cells (as the target cells identities), where appropriate or sufficient.

Optionally, the CU-UP may inform the CU-CP about the bearer context modification based on the notification of the Source DU in step 16.

Upon the triggering of the early data forwarding (in step 14), in one option/alternative denoted as “CU-UP Notification through CU-CP”, the Source DU notifies the CU-CP about the early data forwarding decision, wherein the identities of the candidate target cells, i.e. the Target DUs, is notified/informed and it is notified/informed that the upcoming serving cell change is an inter-DU cell change (i.e. the property of the upcoming serving cell change), in step 17. This can be accomplished using a corresponding notification or message. As illustrated, the notification or message can contain (a list of) the NR-CGIs of the candidate target cell (as the target cells identities) to enable the CU-CP to perform bearer context modification with the CU-UP, i.e. issue a bearer context modification request to notify the CU-UP (thus enabling the CU-UP to perform (preparation or initiation of) the data forwarding). In an alternative implementation, the notification or message can contain (a list of) the PCIs of the candidate target cells (as the target cells identities), where appropriate or sufficient (together with the inter-DU cell change indication).

The CU-CP performs bearer modification with the CU-UP in steps 18 and 19 to update the bearer setup and for the CU-UP to start forwarding the data to the candidate Target DUs. Once this is completed, the data is forwarded to and thus available at the candidate Target DU, as illustrated (for the subsequently selected actual Target DU) in step 20.

In Step 22, the Source DU decides about the need for a serving cell change (or, stated in other words, a cell/path switch), including the initiation of data forwarding to the thus selected actual Target DU, which can be accomplished based on the UE L1 measurements received in step 21.

In step 23, the Source DU sends a corresponding MAC CE to the UE to trigger the serving cell change.

Upon the triggering of the serving cell change (in steps 22/23), the Source DU notifies the CU-UP of (the serving cell change decision by way of) a downlink data delivery status indicating downlink data having been acknowledged by the UE as a destination. For example, as illustrated in step 24, the Source DU informs the CU-UP, e.g. with a Control PDU, about the downlink data delivery status, i.e. the PDUs that have been acknowledged by the UE. Thereupon, the CU-UP notifies/provides the downlink data delivery status to the Target DU in step 29. Thereby, the Target DU knows which PDUs have already been acknowledged (i.e. received by/via the Source DU) and can thus be released or discarded.

In one option/alternative denoted as “Direct CU-UP Notification”, the Source DU notifies the CU-UP of the downlink data delivery status in or together with an indication or message, such as a Control PDU, in or with which the Source DU also notifies the CU-UP about the serving cell change decision, wherein the identity of the target cell, i.e. the Target DU, is notified/informed, as illustrated in step 24. As illustrated, the notification or message can contain the NR-CGI of the target cell (as the target cell identity) to enable the cell/path switch, as the NR-CGI helps the CU-UP to identify the target cell, i.e. the Target DU. In an alternative implementation, the notification or message can contain the PCI of the target cell (as the target cell identity), where appropriate or sufficient.

Optionally, the CU-UP may inform the CU-CP about the bearer context modification based on the notification of the Source DU in step 25.

It is to be noted that even in this option/alternative, the Source DU may notify the CU-UP about the downlink data delivery status and about the serving cell change decision in different/separate notifications or messages. For example, the DU may notify the CU-UP about (only) the downlink data delivery status first, such as in/with the Control PDU illustrated in step 24, and the Source Du may notify the CU-CP about (only) the serving cell change decision, together with the target cell identifier) concurrently or thereafter, such as in/with another Control PDU which is not illustrated but can occur at any time between steps 23 and 25.

In one option/alternative denoted as “CU-UP Notification through CU-CP”, the Source DU notifies the CU-CP about the serving cell change decision using a corresponding notification or message different/apart from an indication or message, such as a Control PDU, in or together with which the Source DU notifies the CU-UP of the downlink data delivery status. In such notification or message, the identity of the target cell, i.e. the Target DU, is notified/informed and it is notified/informed that the serving cell change is an inter-DU cell change (i.e. the property of the serving cell change), as illustrated in step 26. As illustrated, the notification or message can contain the NR-CGI of the target cell (as the target cell identity) to enable the CU-CP to perform bearer context modification with the CU-UP, i.e. issue a bearer context modification request to notify the CU-UP (thus enabling the CU-UP to perform the cell/path switch). In an alternative implementation, the notification or message can contain the PCI of the target cell (as the target cell identity), where appropriate or sufficient (together with the inter-DU cell change indication).

The CU-CP performs bearer modification with the CU-UP in steps 27 and 28 to update the bearer setup and for the CU-UP to start forwarding the data to the Target DU (and stop forwarding the data to the Source DU). Once this is completed, the data is forwarded to and thus available at the Target DU.

Then (or at least partially parallel with any one of the above notifications options/alternatives with respect to the serving cell change), the UE applies the RRC configuration for the target cell, i.e. the Target DU, as indicated by the MAC CE, and performs a handover procedure, such as e.g. RA-based handover, RACH-less handover, or the like. Herein, it is exemplarily assumed that the UE performs Random Access (RA) to the target cell, i.e. the Target DU, in steps 30 and 31. After the RA procedure or any other (inter-DU) handover procedure, the UE in step 32 transmits an RRC Reconfiguration Complete to the target cell, i.e. the Target DU, which is forwarded to the CU-CP in step 34. Upon the RRC Reconfiguration Complete in step 32, i.e. upon performing/completing the serving cell change to the target cell, the UE starts receiving data from the Target DU, as illustrated in step 33.

Steps 35 and 36 are equivalent to steps 22 and 23 described above for FIG. 4, and thus reference is made to the related description of FIG. 4 for details.

Although not illustrated in FIG. 6, the Source DU may decide at some point (i.e. after the decision on initiating the early data forwarding in step 14 of FIG. 6 and before e.g. the decision on performing the cell/path switch in step 22 of FIG. 6) that the early data forwarding should be stopped/terminated, i.e. make early data forwarding cancellation decision. Such decision may be taken based on the condition of stopping early data forwarding (when provided by the CU-CP). If so, the Source DU may initiate stop/termination of the early data forwarding by sending a respective notification of the early data forwarding cancellation decision, e.g. by issuing a cancellation message, either to the CU-CP or to the CU-UP.

As evident from the above, early data forwarding according to at least one exemplifying embodiment provides that the Source DU decides when the data forwarding should be initiated (irrespective or, particularly before, a serving cell change decision) and informs the CU-CP or the CU-UP accordingly, indicating the (relevant) potential/candidate target cells or Target DUs to the CU-CP or CU-UP. The CU-UP can continue forwarding and receiving data to/from the Source DU until further confirmation is received from the Source DU to stop Source DU communication. In this regard, the Source DU communicate its decision/indication to the CU-UP either directly or indirectly, namely to the CU-UP (e.g. using a Control PDU) or to the CU-CP and through that to the CU-UP (over the E1 interface or reference point there-between).

According to at least one exemplifying embodiment, which is applicable in any one of the procedures of FIGS. 5 and 6, the CU-CP can decide/determine about the application of on-time data forwarding or early data forwarding, e.g. based on certain settings, requests, constraints, or the like. Based on such decision/determination, the CU-CP can establish the configuration of lower-layer mobility and data forwarding in lower-layer mobility accordingly, i.e. configure the Source DU accordingly.

According to at least one exemplifying embodiment, target cell indexing may be used for identifying (potential/candidate) target cells or corresponding Target DUs. Such target cell indexing is applicable in any one of the procedures of FIGS. 5 and 6.

For target cell indexing, the CU-CP can set an index for each potential target cell of lower-layer mobility, and the CU-CP can provide the index for each potential target cell of lower-layer mobility to the Source DU and the CU-UP. The provisioning to the Source DU may be accomplished in, together with or related with the configuration of L1/L2 centric mobility (such as in step 9 of any one of FIGS. 5 and 6), and the provisioning to the CU-UP may be accomplished with any dedicated or any other indication or message.

For example, the CU-CP may provide to the CU-UP an index for each of the potential target (i.e. prepared) cells with the bearer context setup request (i.e. step 6 of any one of FIGS. 5 and 6). The same indices for the potential target cells are provided to the Source DU as well. In such case, the Source DU, with the Cell Change Triggering (i.e. any one of steps 16 and 18 of FIG. 5, or any one of steps 15, 17, 24 and 26 of FIG. 6) can provide only the index number of the target cell/s and not another identifier such as the NR-CGI with the corresponding indication or message, such as the Control PDU. Thereby, a potential PCI duplication issue among the prepared target cells can be resolved, and signaling optimization can be achieved.

By virtue of exemplifying embodiments of the present disclosure, as evident from the above, there are provided measures/mechanisms for (enabling/realizing) efficient/favorable data forwarding in lower-layer mobility in/for a mobile communication system, namely a radio access network of a mobile communication system, such as L1/L2 centric mobility. Also, there are provided measures/mechanisms for facilitating reduced (service) interruption time and/or reduced (signaling) overhead in/for data forwarding in lower-layer mobility, such as L1/L2 centric mobility.

Accordingly, objectives of lower-layer mobility such as L1/L2 centric mobility (L1/L2 based inter-cell mobility/handover), such as reduced (service) interruption time and/or reduced (signaling) overhead in/for data forwarding, can be favorably achieved. More specifically, it can be achieved that data (to be forwarded) is available at the target cell or Target DU in a timely manner (i.e. before required by the UE due to completion of handover execution), and the data (to be forwarded) is not unnecessarily forwarded to all prepared target cells or more prepared target cells than needed/expedient, thus reducing (excessive) overhead over the F1 interface or reference point between CU-UP and DU.

Accordingly, achievable effects/advantages according to one or more exemplifying embodiments include at least the following:
reduced (service) interruption time compared to late data forwarding triggered after the cell change,
reduced (service) interruption time by (at least partially) parallel execution of F1AP procedures (e.g. those steps included in the boxes for the various options/alternatives in any one of FIGS. 5 and 6) and RRC procedures,
reduced (service) interruption time in case of early data forwarding, as the data is not forwarded by the CU-UP to all prepared cells but only to the relevant ones,
data forwarding is only performed for a short time, but nor excessively long (as may happen with conventional mechanisms of early data forwarding),
signaling optimization with direct DU to CU-UP communication.

Various further beneficial aspects which can be achieved according to one or more exemplifying embodiments include the following:

A proper UE configuration can be specified so as to enable fast application of the configuration (which will further enable low interruption) and the dynamic switch among candidate cells. In order for these procedures to enable low interruption time, it can be ensured that the UE data will be timely available in the node that the UE will be handed over to.

No complete L2 (and L1) resets are required, thus avoiding longer latency, larger overhead and longer interruption time than beam switch mobility. Rather, a serving cell change via L1/L2 signaling is enabled, this reducing the latency, overhead and interruption time.

Configuration and maintenance for multiple candidate cells is enabled to allow fast application of configurations for candidate cells.

A dynamic switch mechanism among candidate serving cells (including SpCell and SCell) for the potential applicable scenarios based on L1/L2 signaling is enabled.

CU-DU interface signaling is enabled to support L1/L2 mobility.

The above-described functionality as well as its related operations, procedures, methods and processes may be implemented by respective functional elements, entities, modules, units, processors, or the like, as described below. These functional elements, entities, modules, units, processors, or the like, i.e. the implementation of one or more exemplifying embodiments, may be realized in a cloud environment, by SDN, by NFV/NFVI, or the like.

While in the foregoing exemplifying embodiments of the present disclosure are described mainly with reference to operations, procedures, methods and processes, corresponding exemplifying embodiments of the present disclosure also cover respective apparatuses, entities, modules, units, network nodes and/or systems, including software and/or hardware thereof.

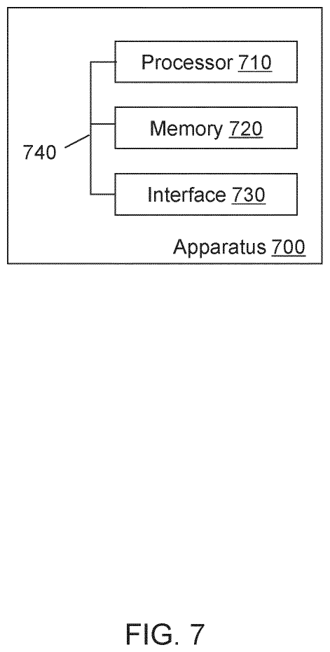

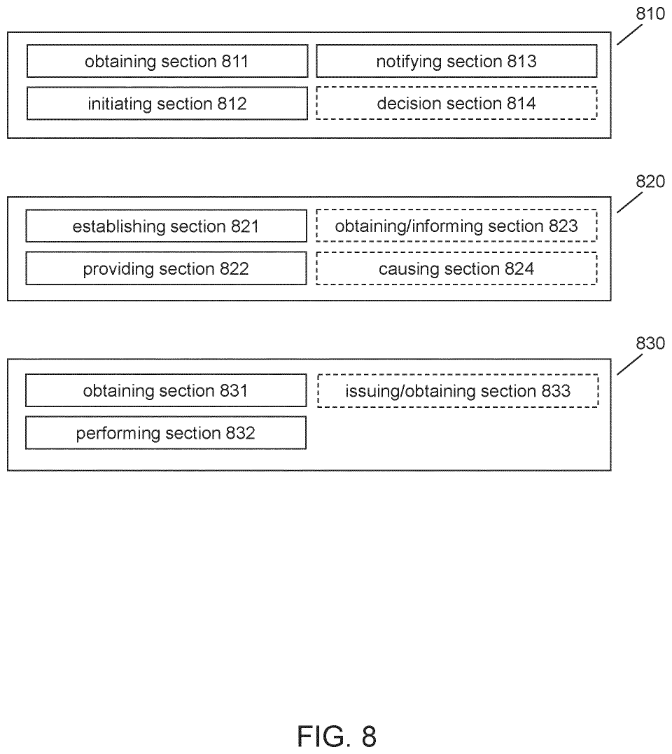

Respective exemplifying embodiments of the present invention are described below referring to FIGS. 7 and 8, while for the sake of brevity reference is made to detailed of the description respective corresponding configurations/setups, schemes, processes, sequences, methods as well as functionalities, principles and operations according to FIGS. 1 to 6.

In FIGS. 7 and 8, the blocks are basically configured to perform respective methods, procedures and/or functions as described above. The entirety of blocks are basically configured to perform the methods, procedures and/or functions as described above, respectively. With respect to FIGS. 7 and 8, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIGS. 7 and 8, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories or the like. Among others, one or more memories are provided for storing programs or program instructions for controlling or enabling the individual functional entities or any combination thereof to operate as described herein in relation to exemplifying embodiments.

FIG. 7 shows a schematic diagram illustrating an example of a structure of apparatuses according to at least one example embodiment. Herein, an apparatus can represent a physical entity or component, e.g. a structural device implementing a specific network element, entity or function or the functionality thereof as such, or a functional or logical entity or component. For example, the illustrated apparatus may be realized in or by a server or the like in a cloud environment, e.g. by a cloud-based implementation.

As indicated in FIG. 7, according to at least one example embodiment, an apparatus 700 may comprise or realize at least one processor 710 and at least one memory 720 (and possibly also at least one interface 730), which may be operationally connected or coupled, for example by a bus 740 or the like, respectively.

The processor 710 and/or the interface 730 of the apparatus 700 may also include a modem or the like to facilitate communication over a (hardwire or wireless) link, respectively. The interface 730 of the apparatus 700 may include a transmitter, receiver or transceiver connected or coupled to one or more antennas, antenna units, such as antenna arrays or communication facilities or means for (hardwire or wireless) communications with the linked, coupled or connected device(s), respectively. The interface 730 of the apparatus 700 is generally configured to communicate with at least one other apparatus, device, node or entity (in particular, the interface thereof).

The memory 720 of the apparatus 700 may represent a (non-transitory/tangible) storage medium (e.g. RAM, ROM, EPROM, EEPROM, etc.) and store respective software, programs, program products, macros or applets, etc. or parts of them, which may be assumed to comprise program instructions or computer program code that, when executed by the respective processor, enables the respective electronic device or apparatus to operate in accordance with example embodiments described herein. Further, the memory 720 of the apparatus 700 may (comprise a database to) store any data, information, or the like, which is used in the operation of the apparatus.

According to various example embodiments, respective apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the illustrated apparatus 700 can be used in practicing one or more of the example embodiments, as described herein.

When in the subsequent description it is stated that the processor (or some other means) is configured to perform some function, this is to be construed to be equivalent or corresponding to a description stating that a (i.e. at least one) processor or corresponding circuitry, potentially in cooperation with a computer program code stored in the memory of the respective apparatus or otherwise available (it should be appreciated that the memory may also be an external memory or provided/realized by a cloud service or the like), is configured to cause the apparatus to perform at least the thus mentioned function. It should be appreciated that herein processors, or more generally processing portions, should not be only considered to represent physical portions of one or more processors, but may also be considered as a logical division of the referred processing tasks performed by one or more processors.

According to at least one example embodiment, the illustrated apparatus 700 may represent or realize/embody a (part of a) lower-layer entity, or an element, function or entity of similar/comparable functionality or operability, in/for a radio access network of a mobile communication system, such as a communication and/or communication control unit like a Distributed Unit DU (of/in a gNB) in/for a 3GPP network or system. Hence, the apparatus 700 may be configured to perform a procedure and/or exhibit a functionality and/or implement a mechanism, as described (for Source DU) in any one of FIGS. 1 and 4 to 6.

Accordingly, the apparatus 700 may be caused or the apparatus 700 or its at least one processor 710 (possibly together with computer program code stored in its at least one memory 720) may be configured to obtain a configuration of lower-layer mobility and data forwarding in lower-layer mobility from a higher-layer control plane entity, to initiate data forwarding to at least one target cell of lower-layer mobility in accordance with the configuration, and to notify a higher-layer user plane entity of initiation of data forwarding, wherein the at least one target cell of lower-layer mobility is identified.

According to at least one example embodiment, the illustrated apparatus 700 may represent or realize/embody a (part of a) higher-layer control plane entity, or an element, function or entity of similar/comparable functionality or operability, in/for a radio access network of a mobile communication system, such as a communication and/or communication control unit like a Central Unit-Control Plane CU-CP (of/in a gNB) in/for a 3GPP network or system. Hence, the apparatus 700 may be configured to perform a procedure and/or exhibit a functionality and/or implement a mechanism, as described (for CU-CP) in any one of FIGS. 2 and 4 to 6.

Accordingly, the apparatus 700 may be caused or the apparatus 700 or its at least one processor 710 (possibly together with computer program code stored in its at least one memory 720) may be configured to establish a configuration of lower-layer mobility and data forwarding in lower-layer mobility, and to provide the configuration to a lower-layer entity.

According to at least one example embodiment, the illustrated apparatus 700 may represent or realize/embody a (part of a) higher-layer user plane entity, or an element, function or entity of similar/comparable functionality or operability, in/for a radio access network of a mobile communication system, such as a communication and/or communication control unit like a Central Unit-User Plane CU-UP (of/in a gNB) in/for a 3GPP network or system. Hence, the apparatus 700 may be configured to perform a procedure and/or exhibit a functionality and/or implement a mechanism, as described (for CU-UP) in any one of FIGS. 3 and 4 to 6.

Accordingly, the apparatus 700 may be caused or the apparatus 700 or its at least one processor 710 (possibly together with computer program code stored in its at least one memory 720) may be configured to obtain notifying information of initiation of data forwarding in lower-layer mobility by a lower-layer entity, and to perform data forwarding in accordance with the notifying information.

As mentioned above, an apparatus according to at least one example embodiment may be structured by comprising respective one or more units or means or circuitries for performing corresponding operations, procedures and/or functions. For example, such one or more units or means or circuitries may be implemented/realized on the basis of an apparatus structure, as illustrated in FIG. 7, e.g. by one or more processors 710, one or more memories 720, one or more interfaces 730, or any combination thereof.

FIG. 8 shows a schematic diagram illustrating an example of a structure of apparatuses according to at least one example embodiment.

As shown in FIG. 8, an apparatus 810 according to at least one example embodiment may represent or realize/embody a (part of a) lower-layer entity, or an element, function or entity of similar/comparable functionality or operability, in/for a radio access network of a mobile communication system, such as a communication and/or communication control unit like a Distributed Unit DU (of/in a gNB) in/for a 3GPP network or system. Hence, the apparatus 810 may be configured to perform a procedure and/or exhibit a functionality and/or implement a mechanism, as described (for Source DU) in any one of FIGS. 1 and 4 to 6.

Such apparatus 810 may comprise (at least) one or more unit/means/circuitry, denoted by obtaining section 811, which represent any implementation for (or configured to) obtaining (obtain) a configuration of lower-layer mobility and data forwarding in lower-layer mobility from a higher-layer control plane entity, one or more unit/means/circuitry, denoted by initiating section 812, which represent any implementation for (or configured to) initiating (initiate) data forwarding to at least one target cell of lower-layer mobility in accordance with the configuration, and one or more unit/means/circuitry, denoted by notifying section 813, which represent any implementation for (or configured to) notifying (notify) a higher-layer user plane entity of initiation of data forwarding, wherein the at least one target cell of lower-layer mobility is identified.

Further, such apparatus 810 may additionally/optionally further comprise one or more unit/means/circuitry, denoted by decision section 814, which represent any implementation for (or configured to) making (make) a decision, such as a serving cell change decision for a target cell for lower-layer mobility, a serving cell change decision for a target cell among the one or more candidate target cells for lower-layer mobility, an upcoming serving cell change decision for a target cell among the one or more candidate target cells for lower-layer mobility, or an early data forwarding cancellation decision for cancelling the early data forwarding.

As shown in FIG. 8, an apparatus 820 according to at least one example embodiment may represent or realize/embody a (part of a) higher-layer control plane entity, or an element, function or entity of similar/comparable functionality or operability, in/for a radio access network of a mobile communication system, such as a communication and/or communication control unit like a Central Unit-Control Plane CU-CP (of/in a gNB) in/for a 3GPP network or system. Hence, the apparatus 820 may be configured to perform a procedure and/or exhibit a functionality and/or implement a mechanism, as described (for CU-CP) in any one of FIGS. 2 and 4 to 6.

Such apparatus 820 may comprise (at least) one or more unit/means/circuitry, denoted by establishing section 821, which represent any implementation for (or configured to) establishing (establish) a configuration of lower-layer mobility and data forwarding in lower-layer mobility, and one or more unit/means/circuitry, denoted by providing section 822, which represent any implementation for (or configured to) providing (provide) the configuration to a lower-layer entity.

Further, such apparatus 820 may additionally/optionally further comprise one or more unit/means/circuitry, denoted by obtaining/informing section 823, which represent any implementation for (or configured to) performing (perform) one or more of various obtaining/informing operations or steps, as described above. Additionally or alternatively, such apparatus 820 may additionally/optionally comprise (at least) one or more unit/means/circuitry, denoted by causing section 824, which represent any implementation for (or configured to) causing (cause) bearer context modification at the higher-layer user plane entity.

As shown in FIG. 8, an apparatus 830 according to at least one example embodiment may represent or realize/embody a (part of a) higher-layer user plane entity, or an element, function or entity of similar/comparable functionality or operability, in/for a radio access network of a mobile communication system, such as a communication and/or communication control unit like a Central Unit-User Plane CU-UP (of/in a gNB) in/for a 3GPP network or system. Hence, the apparatus 830 may be configured to perform a procedure and/or exhibit a functionality and/or implement a mechanism, as described (for CU-UP) in any one of FIGS. 3 and 4 to 6.

Such apparatus 830 may comprise (at least) one or more unit/means/circuitry, denoted by obtaining section 831, which represent any implementation for (or configured to) obtaining (obtain) notifying information of initiation of data forwarding in lower-layer mobility by a lower-layer entity, and one or more unit/means/circuitry, denoted by performing section 832, which represent any implementation for (or configured to) performing (perform) data forwarding in accordance with the notifying information.

Further, such apparatus 830 may additionally/optionally further comprise one or more unit/means/circuitry, denoted by issuing/obtaining section 833, which represent any implementation for (or configured to) performing (perform) one or more of various issuing/obtaining operations or steps, as described above.

For further details regarding the operability/functionality of the apparatuses (or units/means thereof) according to exemplifying embodiments, reference is made to the above description in connection with any one of FIGS. 1 to 6, respectively.

According to exemplifying embodiments of the present disclosure, any one of the (at least one) processor, the (at least one) memory and the (at least one) interface, as well as any one of the illustrated units/means, may be implemented as individual modules, chips, chipsets, circuitries or the like, or one or more of them can be implemented as a common module, chip, chipset, circuitry or the like, respectively.

According to exemplifying embodiments of the present disclosure, a system may comprise any conceivable combination of any depicted or described apparatuses and other network elements or functional entities, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, a basic system architecture of a (tele) communication network including a mobile communication system where some examples of exemplifying embodiments are applicable may include an architecture of one or more communication networks including wireless access network sub-/system(s) and possibly core network(s). Such an architecture may include one or more communication network control elements or functions, such as e.g. access network elements, radio access network elements, access service network gateways or base transceiver stations, like a base station, an access point, a NodeB (NB), an eNB or a gNB, a distributed or a centralized unit, which controls a respective coverage area or cell(s) and with which one or more communication stations such as communication elements or functions, like user devices or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. It should be appreciated that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of exemplifying embodiments may also be able to communicate with other networks, such as a public switched telephone network or the Internet, including the Internet-of-Things. The communication network may also be able to support the usage of cloud services for virtual network elements or functions thereof, wherein it is to be noted that the virtual network part of the (tele) communication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g. a cloud infrastructure.

Any method step is suitable to be implemented as software or by hardware without changing the idea of the present disclosure. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units/means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for enabling/realizing efficient/favorable data forwarding in lower-layer mobility in/for a mobile communication system, namely a radio access network of a mobile communication system, such as L1/L2 centric mobility. Such measures exemplarily comprise that a lower-layer entity in a radio access network of a mobile communication system obtains a configuration of lower-layer mobility and data forwarding in lower-layer mobility from a higher-layer control plane entity, initiates data forwarding to at least one target cell of lower-layer mobility in accordance with the configuration, and notifies a higher-layer user plane entity of initiation of data forwarding, wherein the at least one target cell of lower-layer mobility is identified. The configuration may indicate on-time data forwarding, wherein data forwarding to a target cell is triggered when a serving cell change decision is completed, or ay indicate early data forwarding upon preparation of candidate target cells for lower-layer mobility, wherein data forwarding to at least one of one or more candidate target cells is triggered when candidate target cells preparation is completed.

Even though the present disclosure is described above with reference to the examples according to the accompanying drawings, it is to be understood that the present disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

3GPP 3rd Generation Partnership Project
5G 5th Generation
CU-CP Central Unit—Control Plane
CU-UP Central Unit—User Plane
DL Downlink
DU Distributed Unit
gNB gNodeB (5G/NR base station)
HO Handover
MAC Medium Access Control
MAC CE Medium Access Control Control Element
NFV Network Functions Virtualisation
NFVI Network Functions Virtualisation Infrastructure
NR New Radio
NR-CGI New Radio Cell Global Identity/Identifier
OSI Open Systems Interconnection
PCI Physical Cell Identity/Identifier
PDU Packet Data Unit
RA Random Access
RACH Random Access Channel
RRC Radio Resource Control
SDN Software-Defined Networking
UE User Equipment
UL Uplink

1-27. (canceled)

28. A method for supporting lower-layer processing in a radio access network of a mobile communication system, comprising:
obtaining a configuration of lower-layer mobility and data forwarding in lower-layer mobility from an apparatus supporting higher-layer control plane processing,
initiating data forwarding towards an apparatus supporting at least one target cell of lower-layer mobility in accordance with the configuration, and
notifying an apparatus supporting higher-layer user plane processing of initiation of data forwarding, wherein the at least one target cell of lower-layer mobility is identified.

29. The method according to claim 28, wherein
the configuration indicates on-time data forwarding upon decision of serving cell change for lower-layer mobility.

30. The method according to claim 29, wherein the initiating comprises:
making a serving cell change decision for a target cell for lower-layer mobility, and triggering data forwarding to the target cell when the serving cell change decision is completed.

31. The method according to claim 30, wherein the notifying comprises:
issuing a notification towards the apparatus supporting higher-layer user plane processing, said notification including an indication of the serving cell change decision and an identifier for the target cell, or
issuing a notification towards the apparatus supporting the higher-layer control plane processing, for informing the higher-layer user plane apparatus, said notification including an indication of the serving cell change decision, an indication of the property of the serving cell change as a change between serving cells relating to different lower-layer apparatus and an identifier for the target cell.

32. The method according to claim 28, wherein
the configuration indicates early data forwarding upon preparation of candidate target cells for lower-layer mobility.

33. The method according to claim 32, wherein the initiating comprises:
conducting a candidate target cells preparation for one or more candidate target cells for lower-layer mobility, and
triggering data forwarding to at least one of the one or more candidate target cells when the candidate target cells preparation is completed.

34. The method according to claim 33, wherein the notifying comprises:
issuing a notification towards the higher-layer user plane apparatus, said notification including an indication of application of the early data forwarding and an identifier for the at least one of the one or more candidate target cells, or
issuing a notification towards the higher-layer control plane apparatus, for informing the higher-layer user plane apparatus, said notification including an indication of application of the early data forwarding, an indication of the property of an upcoming serving cell change as a change between serving cells relating to different lower-layer apparatus and an identifier for the at least one of the one or more candidate target cells.

35. The method according to claim 33, further comprising:
making a serving cell change decision for a target cell among the one or more candidate target cells configured for lower-layer mobility, and
notifying the higher-layer user plane apparatus of the serving cell change decision, wherein the notifying of the serving cell change decision comprises issuing a notification towards the higher-layer user plane apparatus, said notification including an indication of a downlink data delivery status indicating downlink data having been acknowledged by a user equipment.

36. The method according to claim 35, wherein the notifying of the serving cell change decision further comprises:
issuing a notification towards the higher-layer user plane apparatus, said notification including an indication of the serving cell change decision and an identifier for the target cell, or
issuing a notification towards the higher-layer control plane apparatus, for informing the higher-layer user plane apparatus, said notification including an indication of the serving cell change decision, an indication of the property of the serving cell change as a change between serving cells relating to different lower-layer apparatus and an identifier for the target cell.

37. The method according to claim 33, further comprising:
making an early data forwarding cancellation decision for cancelling the early data forwarding, and
notifying the higher-layer user plane apparatus of the early data forwarding cancellation decision,
wherein the notifying of the early data forwarding cancellation decision comprises issuing a notification towards the higher-layer user plane apparatus or to the higher-layer control plane apparatus, for informing the higher-layer user plane apparatus, said notification including an indication of cancellation of the early data forwarding.

38. The method according to claim 28, wherein
the data forwarding is initiated based on lower-layer measurements, particularly Layer 1 measurements, from a user equipment.

39. The method according to claim 28, wherein
the configuration comprises an individual index for each potential target cell of lower-layer mobility, and
in the notifying the at least one target cell of lower-layer mobility is identified using or based on its index in the configuration.

40. A method for supporting higher-layer control plane processing in a radio access network of a mobile communication system, comprising:
establishing a configuration of lower-layer mobility and data forwarding in lower-layer mobility, and
providing the configuration towards an apparatus supporting lower-layer processing.

41. The method according to claim 38, wherein
the configuration indicates on-time data forwarding upon decision of serving cell change for lower-layer mobility.

42. The method according to claim 41, further comprising:
obtaining a notification of bearer context modification from a higher-layer user plane apparatus, said notification including an indication of a serving cell change decision by the lower-layer apparatus and an indication of initiation of data forwarding to a target cell for lower-layer mobility.

43. The method according to claim 41, further comprising:
obtaining a notification from the lower-layer apparatus, said notification including an indication of a serving cell change decision by the lower-layer apparatus, an indication of the property of the serving cell change as a change between serving cells relating to different lower-layer apparatus and an identifier for a target cell for lower-layer mobility, and
informing a higher-layer user plane apparatus about initiation of data forwarding to the target cell based on the notification.

44. The method according to claim 40, wherein
the configuration indicates early data forwarding upon preparation of candidate target cells for lower-layer mobility.

45. The method according to claim 44, further comprising:
obtaining a notification of bearer context modification from a higher-layer user plane apparatus, said notification including an indication of an upcoming serving cell change decision by the lower-layer apparatus and an indication of initiation of data forwarding to at least one of one or more candidate target cells for lower-layer mobility.

46. The method according to claim 44, further comprising:
obtaining a notification from the lower-layer apparatus, said notification including an indication of application of the early data forwarding by the lower-layer apparatus, an indication of the property of an upcoming serving cell change as a change between serving cells relating to different lower-layer apparatus and an identifier for the at least one of the one or more candidate target cells, and
informing a higher-layer user plane apparatus about initiation of the early data forwarding to the at least one of one or more candidate target cells based on the notification.

47. The method according to claim 40, further comprising:
setting an individual index for each potential target cell of lower-layer mobility, wherein
the index for each potential target cell of lower-layer mobility is provided to the lower-layer apparatus in the configuration and to a higher-layer user plane apparatus.

48. A computer program product comprising computer program code which, when the computer program code is executed on a computer, is configured to cause the computer to carry out the method according to claim 28.

49. A computer program product comprising computer program code which, when the computer program code is executed on a computer, is configured to cause the computer to carry out the method according to claim 40.

50. An apparatus for supporting lower-layer processing in a radio access network of a mobile communication system, the apparatus comprising at least one processor and at least one memory including computer program code, wherein the processor, with the at least one memory and the computer program code, is configured to cause the apparatus to perform:
obtain a configuration of lower-layer mobility and data forwarding in lower-layer mobility from an apparatus supporting higher-layer control plane processing,
initiate data forwarding towards an apparatus supporting at least one target cell of lower-layer mobility in accordance with the configuration, and
notify an apparatus supporting higher-layer user plane processing of initiation of data forwarding, wherein the at least one target cell of lower-layer mobility is identified.

51. The apparatus according to claim 50, wherein
the notifying information indicates on-time data forwarding upon decision of serving cell change for lower-layer mobility.
